(19) United States
(12) Patent Application Publication
(10) Pub. No.: US 2005/0015605 A1
(43) Pub. Date: Jan. 20, 2005

(54) System and method for ensuring mobile device data and content security

(76) Inventor: Jeou-Kai Lin, Campbell, CA (US)

Correspondence Address: FORTUNE LAW GROUP, 100 Century Center Ct., San Jose, CA, 95112, US

(21) Appl. No.: 10/891,163

(22) Filed: Jul. 14, 2004

Related U.S. Application Data
(60) Provisional application No. 60/487,446, filed on Jul. 15, 2003.

(51) Int. Cl. H04K 1/00

(52) U.S. Cl. 713/185

(57) ABSTRACT

A method for ensuring mobile device data and content security includes the steps of intercepting an active file process, reading a user credential, a process credential and a parent process, reading a pre-set credential, comparing the user credential and the process credential with the pre-set credential, allowing the active file process to proceed if the user credential and the process credential match the pre-set credential, and denying the active file process to proceed if the user credential and the process credential do not match the pre-set credential.

### CROSS REFERENCE TO RELATED APPLICATIONS

The present application claims priority under 35 U.S.C. 119(e) from provisional patent application Ser. No. 60/487,446, entitled “System and Method for Ensuring Mobile Device Data and Content Security”, filed on Jul. 15, 2003, the disclosure of which is herein incorporated by reference in its entirety.

### BACKGROUND OF THE INVENTION

The present invention generally relates to network security and more particularly to a system and method for ensuring mobile device data and content security.

One of the most prevalent security breaches on the Internet involves the download of hostile application, java classes or ActiveX applications to mobile devices. These hostile entities sometimes are very hard to detect. The programs themselves look like normal programs and do not display any abnormal characteristics until much later. These hostile programs may be capable of scanning the cryptographic information that includes security keys and other critical security parameters and reveal this information to hackers. Moreover, if the mobile device gets lost, a thief or other person may easily access the cryptographic information and use this information maliciously.

Some prior art systems and methods encrypt the cryptographic information using common algorithms. These algorithms are easily reverse engineered. In other prior art systems, user attributes are associated with particular files. This method suffers from the disadvantage that user attributes may be obtained at the time of download. Furthermore, a person finding the mobile device in a power-on condition has user privileges.

As can be seen there is a need for a system and method for ensuring mobile device data and content security.

### SUMMARY OF THE INVENTION

In accordance with one aspect of the invention, a method for ensuring mobile device data and content security includes the steps of intercepting an active file process, reading a user credential, a process credential and a parent process, reading a pre-set credential, comparing the user credential and the process credential with the pre-set credential, allowing the active file process to proceed if the user credential and the process credential match the pre-set credential, and denying the active file process to proceed if the user credential and the process credential do not match the pre-set credential.

In accordance with another aspect of the invention, a system for ensuring mobile device data and content security includes a memory comprising program instructions, and a processor coupled to the memory, the processor operable to execute the program instructions to perform the operations of intercepting an active file process, reading a user credential, a process credential and a parent process, reading a pre-set credential, comparing the user credential and the process credential with the pre-set credential, allowing the active file process to proceed if the user credential and the process credential match the pre-set credential, and denying the active file process to proceed if the user credential and the process credential do not match the pre-set credential.

In accordance with yet another aspect of the invention, a computer-readable medium containing one or more instructions for ensuring mobile device data and content security includes a code segment for intercepting an active file process, a code segment for reading a user credential, a process credential and a parent process, a code segment for reading a pre-set credential, a code segment for comparing the user credential and the process credential with the pre-set credential, a code segment for allowing the active file process to proceed if the user credential and the process credential match the pre-set credential, and a code segment for denying the active file process to proceed if the user credential and the process credential do not match the pre-set credential.

These and other features, aspects and advantages of the present invention will become better understood with reference to the following drawings, description and claims.

### BRIEF DESCRIPTION OF THE DRAWINGS

FIG. 1 is a flow diagram of a method in accordance with the present invention; and

FIG. 2 is a schematic representation of a system in accordance with the present invention.

### DETAILED DESCRIPTION OF THE INVENTION

The following detailed description is of the best mode of carrying out the invention. The description is not to be taken in a limiting sense, but is made merely for the purpose of illustrating the general principles of the invention, since the scope of the invention is best defined by the appended claims.

The present invention generally provides a system and method for ensuring mobile device data and content security.

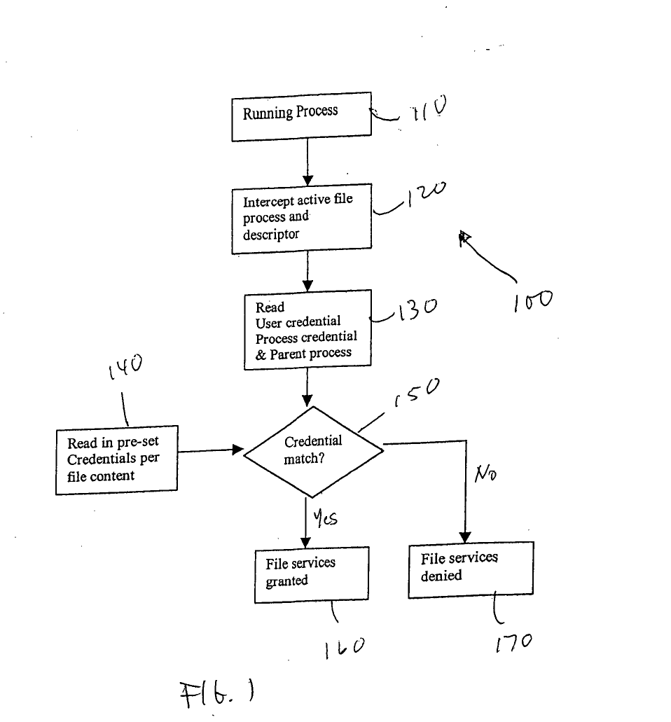

With reference to FIG. 1, a method for ensuring mobile device data and content security is shown generally designated 100. In a step 110 a process is initiated and in a step 120 the process is intercepted along with its descriptor. In a step 130 a user credential, a process credential and a parent process are read and in a step 140 a pre-set credential for the process is read. The pre-set credential for the process is only read if the parent process is a legal process. In a step 150 the credentials are compared. If the credentials match, then in a step 160 the process proceeds, otherwise in a step 170 the process is denied.

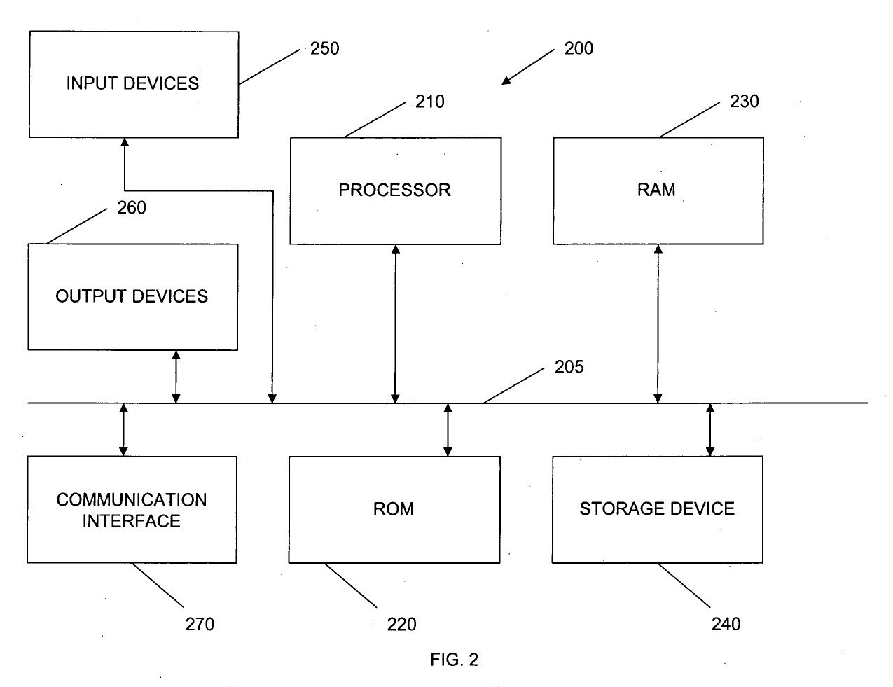

A system generally designated 200 shown in FIG. 2 may be operable to implement method 100. System 200 may include a processor 210 coupled to a bus 205. Processor 210 may be operable to execute instructions stored in a read only memory device 220 and a random access memory device 230 which may be coupled to bus 205. Instructions stored in read only memory device 220 and random access memory device 230 may be operable to implement method 100. System 200 may further include a storage device 240, input devices 250, output devices 260, and communication interface 270 coupled to bus 205.

In another aspect of the invention, a computer readable medium may be operable to store computer readable code operable to implement method 100. Code segments stored in computer readable medium may be operable to instruct processor 210 to implement method 100.

It should be understood, of course, that the foregoing relates to preferred embodiments of the invention and that modifications may be made without departing from the spirit and scope of the invention.

1. A method for ensuring mobile device data and content security comprising the steps of:
intercepting an active file process;
reading a user credential, a process credential and a parent process;
reading a pre-set credential;
comparing the user credential and the process credential with the pre-set credential;
allowing the active file process to proceed if the user credential and the process credential match the pre-set credential; and
denying the active file process to proceed if the user credential and the process credential do not match the pre-set credential.

2. The method as claimed in claim 1, wherein the pre-set credential for the active file process is only read if the parent process is a legal process.

3. A system for ensuring mobile device data and content security comprising:
a memory comprising program instructions; and
a processor coupled to the memory, the processor operable to execute the program instructions to perform the operations of intercepting an active file process, reading a user credential, a process credential and a parent process, reading a pre-set credential, comparing the user credential and the process credential with the pre-set credential, allowing the active file process to proceed if the user credential and the process credential match the pre-set credential, and denying the active file process to proceed if the user credential and the process credential do not match the pre-set credential.

4. The system as claimed in claim 3, wherein the pre-set credential for the active file process is only read if the parent process is a legal process.

5. A computer-readable medium containing one or more instructions for ensuring mobile device data and content security comprising:
a code segment for intercepting an active file process;
a code segment for reading a user credential, a process credential and a parent process;
a code segment for reading a pre-set credential;
a code segment for comparing the user credential and the process credential with the pre-set credential;
a code segment for allowing the active file process to proceed if the user credential and the process credential match the pre-set credential; and
a code segment for denying the active file process to proceed if the user credential and the process credential do not match the pre-set credential.

6. The computer-readable medium as claimed in claim 5, wherein the pre-set credential for the active file process is only read if the parent process is a legal process.
